(19) United States
(12) Patent Application Publication
(10) Pub. No.: US 2022/0083398 A1
(43) Pub. Date: Mar. 17, 2022

(54) APPLICATION CONFIGURABLE SELECTIVE MEMORY COMPRESSION (ACSMC)

(71) Applicant: Intel Corporation, Santa Clara, CA (US)

(72) Inventors: Binuraj RAVINDRAN, San Jose, CA (US); George S. POWLEY, Northborough, MA (US); Rajesh POORNACHANDRAN, Portland, OR (US)

(21) Appl. No.: 17/532,609

(22) Filed: Nov. 22, 2021

(51) Int. Cl. G06F 9/50

(52) U.S. Cl. CPC G06F 9/5083; G06F 9/5016; G06F 9/5033; G06F 9/5077

(57) ABSTRACT

A system can dynamically apply compression to data storage for workloads based on how the compression affects the performance for the workloads. The system can track a service level indicator (SLI) during runtime of a workload and dynamically change a level of compression for the workload based on the SLI. The system can track the SLI to increase compression for the workload while maintaining a performance minimum specified in a service level agreement (SLA) for the workload.

### FIELD

Descriptions are generally related to computer memory, and more particular descriptions are related to compression in memory.

### BACKGROUND

Computer server systems include processor compute resources to perform computations and memory to store data for computation operations by the processor resources. Memory stores data to keep the processors operating at capacity, making it an important resource in server systems. While there can be an advantage to adding more memory to a server system, adding memory adds cost.

To increase memory utilization, current systems will manage working data set size through overcommitting the memory and applying memory page compression. Such a technique to reduce the memory footprint of the data to allow more data to be stored in memory without increasing the memory footprint. There is a tradeoff between applying memory compression and lowering the performance of workloads associated with the data.

Indicators such as page fault rate and memory pressure are traditionally used as a proxy for workload performance is inefficient, which can result in failing to meet a service level agreement set for the workloads. Heterogeneous workloads are affected differently by memory compression, resulting in inconsistent impacts on workload service level agreements by traditional memory compression policies.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a system that dynamically adjusts memory compression based on runtime indicators.

FIG. 2 is a block diagram of an example of a system architecture that tracks runtime indicators to dynamically adjust memory compression.

FIG. 3 is a block diagram of an example of a workload manager that tracks runtime indicators to manage memory compression for workloads.

FIG. 4 is a flow diagram of an example of a process for monitoring runtime performance indicators.

FIG. 5 is a diagrammatic representation of an example of a plot of SLI response to memory reduction.

FIG. 6 is a flow diagram of an example of a process for managing compression by SLI parameters.

FIG. 7 is a block diagram of an example of a multi-node network in which management of compression based on SLI parameters can be implemented.

Descriptions of certain details and implementations follow, including non-limiting descriptions of the figures, which may depict some or all examples, and well as other potential implementations.

### DETAILED DESCRIPTION

As described herein, a system can dynamically apply compression to data storage for individual workloads based on how the compression affects the performance for the workloads. The system can track a service level indicator (SLI) during runtime of a workload and dynamically change a level of compression for the workload based on monitoring of the SLI. The system can track the SLI to increase compression for the workload while maintaining a performance minimum specified in a service level agreement (SLA) for the workload.

Monitoring workload specific SLIs provides specific information on individual workload performance, rather than using platform telemetry to estimate the effects of memory page compression on workload performance. are not directly monitored. Seeing that some workloads are more amenable to compression than others, monitoring the specific impact on a workload provides the ability to specifically adjust compression for a workload while staying within its SLA.

Different workloads have different dataset size, different memory access patterns, and other differences. One common use of memory page compression is to compress “cold” pages, keeping the more active pages in uncompressed format. Thus, workloads with more compressible data and workloads with a lot of cold memory can sustain a higher level of compression than workloads having opposite characteristics.

With heterogenous and dynamic workloads deployed at datacenters, individual workload management provides better memory compression management than traditional approaches that attempt global optimization techniques. Monitoring SLIs for a workload and adjusting a level of compression for the workload based on the SLI can be referred to as workload-aware compression. Workload-aware compression can be referred to as application configurable selective memory compression (ACSMC). Workload-aware compression provides configurable SLA management at the workload level, which can improve the benefits of low-latency compression/decompression engines.

In contrast to traditional uses of compression that provide global compression policies, ACSMC enables applications to configure compression and prefetching algorithms based on the workload data characteristics and affinity. The configuration of the compression and prefetching for applications or workloads can be applied whether the compression applied is hardware assisted compression, or simply software-implemented compression.

Seeing that compression/decompression is data dependent, the compression level in the SLAs can be provisioned to be application-specific and dynamic. While ACSMC can provide workload-aware control, it can also work with default policies in a system, allowing both application-aware and non-application aware techniques to be applied in the system. The default policies can remain in place while the system dynamically updates the application of compression based on platform telemetry and self-learning capability.

ACSMC provides application specific or workload specific compression configurability. Thus, a system can selectively apply compression to data for an application while staying within the bounds of an SLA for the application. The system tracks SLI runtime indicators to manage compression while honoring minimum performance guarantees of the SLA. Thus, the system can apply memory compression without violating the SLA or sacrificing performance for the workload.

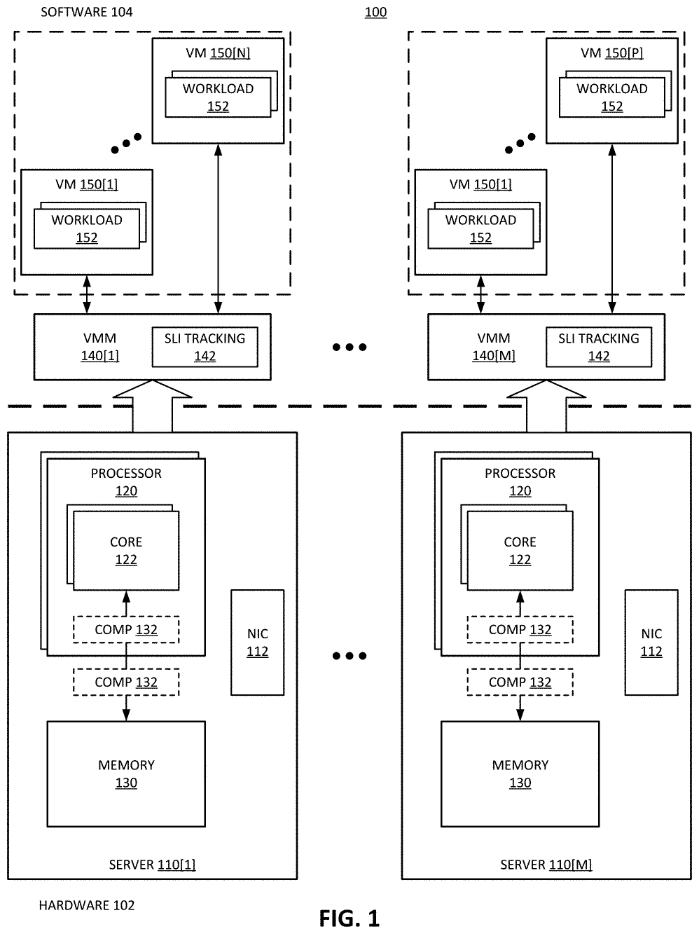

FIG. 1 is a block diagram of an example of a system that dynamically adjusts memory compression based on runtime indicators. System 100 represents a system that monitors runtime indicators for workloads or applications and adjusts a compression level for a workload based on the runtime indicators.

System 100 is represented as hardware 102 and software 104. Hardware 102 includes M servers, server 110[1:M], collectively servers 110. Servers 110 execute software 104, which includes virtual machine managers (VMM) 140[1:M], collectively VMMs 140, to manage the execution of virtual machines or application containers on the servers. In one example, each of servers 110 has a corresponding VMM 140.

VMMs 140 support execution of multiple VMs, identified as VM 150[1:N] for VMM 140[1] of server 110[1], and VM 150[1:P] for VMM 140[M], collectively VMs 150. N, P, and M are integers, and N and P are typically a larger number than M. N and P can be the same number, or can be different integer values.

VMs 150 are illustrated with multiple workloads 152. In one example, each VM 150 is a workload 152. In one example, each VM 150 is an application that generates multiple workloads 152. In one example, each VM 150 is a container or guest operating system that executes operations represented as workloads 152.

Servers 110 include one or more processor devices, represented by processor 120. Processor 120 can be or include central processing units (CPUs), graphics processing units (GPUs), programmable arrays (e.g., field programmable gate array (FPGA)), or other processor. In one example, processor 120 is a multicore processor, with multiple cores 122 or multiple execution units. Core 122 represent the computational core or processing engine of processor 120. There can be multiple cores or processing units or execution units within processor 120 to perform the execution of operations within system 100. The individual execution units or individual cores can be considered a processor, or the processor can be considered to include many cores or many execution units.

Servers 110 include memory 130, which represents memory resources at the server to store data for the operations and computations of processor 120. Memory 130 typically includes volatile memory, such as dynamic random access memory (DRAM) devices, which have indeterminate state if power is interrupted. In one example, servers 110 can include nonvolatile memory, which maintains determinate state even when power is interrupted. In one example, server 110 can include multiple tiers of memory, including volatile and nonvolatile memory.

In one example, servers 110 include compression/decompression capability to selectively compress data to memory 130. Comp 132 represents the compression/decompression engine to provide selective compression to data in memory 130. In one example, comp 132 represents a compression engine that is part of processor 120. An example of comp 132 on processor 120 represents a compression engine closely coupled to the processing resources that will use the compression. In one example, comp 132 is separate from processor 120.

Comp 132 can selectively store data for VMs 150. System 100 can perform compression for VMs 150 based on monitoring service level indicators for VMs 150 or workloads 152. The compression can be specific to SLIs for specific workloads 152 based on SLAs for the workloads. Basing the level of compression on the SLIs can allow system 100 to account for workload dynamics, making the compression application configurable. The application running in the VM can indicate how amenable its workloads are to compression.

In one example, comp 132 can perform memory compression to reduce the footprint of workloads in servers 110. In one example, comp 132 represents software compression, such as compression implemented by a software layer of a memory controller or other controller. In one example, comp 132 represents hardware acceleration for compression. One approach is to save “cold memory” to a compressed tier, while more active data is not compressed. Compression reduces the memory consumption of an individual workload, which reduces the memory cost per application.

VMMs 140 include SLI (service level indicator) tracking 142. SLI tracking 142 enables VMMs 140 to manages VMs 150 based on service level indicators for specific VMs or workloads. Thus, different workloads 152 can have different levels of compression applied by comp 132 for storage of their data in memory 130, based on their performance indicators. SLI tracking 142 enables the application of compression for workloads 152 within an SLA for the VM. Thus, system 100 can ensure that performance indicators for the workload will not fall outside the SLA, while applying as much compression as possible.

Servers 110 can include network interface circuits (NICs) 112. NIC 112 includes hardware interface components to enable the various servers to communicate with each other over a network. NICs 112 enable servers 110 to communicate with a server manager, such as a fleet manager, data center controller, or other controller. In one example, one of the VMs is transferred from one server to another server or from a first server device to a second server device.

Consider, for example, that VM 150[1] of VMM 140[1] on server 110[1] is transferred to server 110[M]. In one example, VMM 140[1] provides telemetry representing SLIs for the VM to VMM 140[M] in response to the transition, or concurrently with transferring the VM to the other server. In one example, compression indicators are specific to a server device. Thus, transferring the telemetry between VMMs allows the receiving VMM to set a different compression level for the VM being transitioned based on new SLI parameters on the new server device.

With system 100 being workload-aware, it can provide finer granularity control for SLA management, as well as providing higher memory savings because of the direct monitoring of the SLIs at the workload level. It will be understood that as comp 132 changes, such as improved compression techniques or implementation of hardware compression/decompression, the new compression abilities can further improve the server performance. Each workload can benefit from improvements to compression given that the different service level parameters can be tracked per VM or per workload.

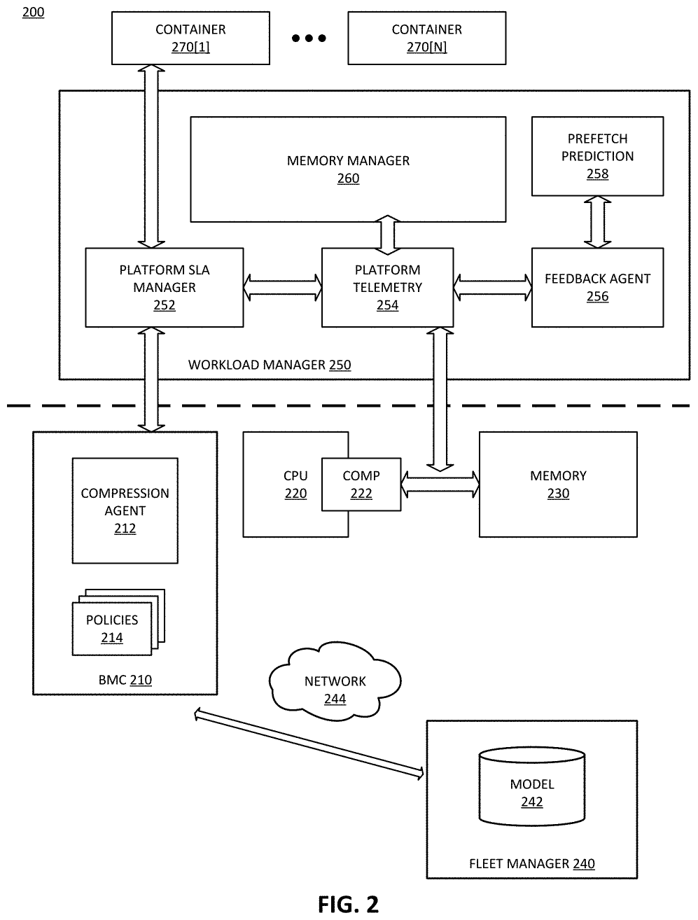

FIG. 2 is a block diagram of an example of a system architecture that tracks runtime indicators to dynamically adjust memory compression. System 200 represents a system in accordance with an example of system 100. System 200 represents elements of a system to execute an ACSMC architecture.

System 200 includes CPU (central processing unit) 220, which represents the hardware compute resources of a server for system 200. System 200 represents a compression accelerator as comp 222, which can compress data for memory 230. An example of a compression accelerator is IAX (Intel analytics accelerator) available from INTEL CORPORATION. Other compression engines can be applied to compress and decompress data for memory 230 based on platform telemetry. Memory 230 represents the memory resources of the server of system 200 to store data for the different workloads. In one example, comp 222 is a compression manager that is implemented in software (software-based compression) executed on CPU 220. In one example, comp 222 represents a compression manager implemented in hardware, such as a controller or control circuit on CPU 220, or a separate controller hardware between CPU 220 and memory 230.

System 200 includes workload manager 250. In one example, workload manager 250 is implemented as a VMM (virtual machine manager). In one example, workload manager 250 is implemented as software executed by CPU 220. In one example, workload manager 250 is implemented as a hardware controller, such as a hardware circuit on CPU 220 or as a separate controller coupled to CPU 220.

Workload manager 250 can manage virtual machines or container groups executed on CPU 220. System 200 illustrates N containers executed on CPU 220, managed by workload manager 250. Container 270[1:N], collectively containers 270, represent the N containers or guest operating systems (OS). Containers 270 can each include one or more applications or one or more workloads for instances of applications. In one example, each of containers 270 has a separate SLI tolerance. Workload manager 250 can perform memory page-compression management for containers 270. Each of containers 270 can include a separate SLA for the container. The SLA can be specified by a user, administrator, or application that caused the container to be initiated and executed. The SLA is typically a function of quality of service (QOS), cost, and other factors. The QOS can be a function of latency, throughput, capacity, bandwidth, reservation policies, or other parameters.

Workload manager 250 includes memory manager 260. Memory manager 260 can be or include a page fault manager, tracking page fault telemetry for virtual machines managed by workload manager 250. In one example, workload manager 250 includes platform SLA (service level agreement) manager 252 to manage the SLA for containers 270. The arrow from platform SLA manager 252 to container 270[1] represents a bidirectional exchange of information between workload manager 250 and containers 270.

In one example, platform SLA manager 252 includes a negotiable interface for scalability to optimize target containers based on other tenants in the system. Thus, platform SLA manager 252 can gather and manage information related to memory compression management for containers 270 based on the SLA for the containers and the SLI related to individual containers 270. Based on the SLA for one of containers 270, platform SLA manager 252 can provision tolerance thresholds, memory squeezing, and compression parameters.

In one example, workload manager 250 includes platform telemetry 254. Platform telemetry 254 can enable workload manager 250 to collect platform telemetry to enhance SLA management. Traditionally, a VMM could monitor memory telemetry, allowing the VMM to track how the memory is being used (e.g., memory usage, memory pressure, available bandwidth, or other parameters). Platform telemetry 254 enables workload manager 250 to gather information about the usage of memory 230 as traditionally done, as well as being able to monitor platform performance parameters for CPU 220. Thus, platform telemetry 254 can indicate information to memory manager 260 regarding timing and performance parameters, which can indicate how changes to compression affect the performance of a container workload.

In one example, workload manager 250 includes feedback agent 256. Feedback agent 256 can collect SLIs from applications to be used along with platform telemetry to fine tune memory compression management for specific containers 270. In one example, workload manager 250 includes prefetch prediction 258. Prefetch prediction 258 can dynamically adjust the prefetch for memory page compression to maximize the resource utilization, especially for optional memory-compression-hardware accelerators with concurrent instances and engines. Prefetch prediction 258 generally indicates how to perform compression for a specific or selected one of containers 270. In one example, prefetch prediction 258 is implemented as a software module within workload manager 250. In one example, prefetch prediction 258 includes at least a portion of a hardware accelerator to gather and manage compression. A hardware implementation can be specifically useful for hardware-accelerated compression. Prefetch prediction 258 can gather and pass the information related to the operating system kernel used to manage the compression for the different containers.

In one example, system 200 utilizes BMC (baseboard management controller) 210 to pass information from workload manager 250 for a specific CPU 220 or specific server to fleet manager 240, which manages workload distribution across servers or across CPUs. Fleet manager 240 can represent a cloud fleet manager that configures each server, operating as a controller to a group of servers. In one example, fleet manager 240 utilizes BMC 210 as a control path to each server or to each CPU.

BMC 210 represents a coprocessor or controller on the system to help with external management. A BMC has traditionally been used to pass information related to thermal thresholds, sensor information, or other platform statistics. In system 200, BMC 210 can be modified to transfer SLA policy information. In one example, BMC 210 can be an additional controller separate from a controller that manages sensor information, which exchanges SLA information with fleet manager 240.

In one example, BMC 210 includes compression agent 212 to enable the transfer of compression information. In one example, compression agent 212 represents an applet executing on BMC 210. Compression agent 212 allows memory compression provisioning and policy management by fleet manager 240. In one example, compression agent 212 obtains data for training offline workload behavioral models. Policies 214 represent the policy information for containers 270 executing on workload manager 250, and thus represent application SLAs. Application SLAs shared by compression agent 212 can be used by a cluster orchestrator (e.g., of fleet manager 240) to select the best host for a given container 270.

In one example, workload manager 250 monitors SLI information, which it passes to BMC 210, which can then be passed to fleet manager 240. Fleet manager 240 and BMC 210 can be connected over network 244, which represents hardware components to interconnect the server controller with the cloud controller. BMC 210 and fleet manager 240 can exchange telemetry information and SLA information over network 244. Based on the telemetry information, fleet manager 240 can determine to move a selected container 270 from one CPU or one server to another. In one example, when a workload is moved from one server to another, the telemetry information can be moved from one workload manager to another workload manager or from one VMM to another VMM.

In one example, fleet manager 240 includes model 242, which represents a workload behavior model. Model 242 can represent a model of the workloads and a model of the system. In one example, fleet manager 240 changes or updates model 242 based on telemetry information passed by BMC 210. Model 242 can include a static offline model for a workload, which can then be updated at runtime based on how the workload behaves and the kind of memory compression it can tolerate within its SLA.

The gathering of telemetry by feedback agent 256 and platform telemetry 254, the action on the telemetry by platform SLA manager 252 and prefetch prediction 258, the updating of the telemetry with fleet manager 240 through BMC 210, and the updating of policies 214 in BMC 210 for containers 270 based on the telemetry from platform SLA manager 252 and determinations by fleet manager 240 can be a telemetry feedback loop and a policy update loop. With the telemetry feedback loop, system 200 forwards SLA information and determines policies for compression management for containers 270 based on the SLAs, then updates the compression management for selected containers 270 based on SLI telemetry gathered during runtime. The policy update loop allows the updating of policies 214 based on decisions by fleet manager 240 based on telemetry information for containers 270.

In system 200, comp 222 can represent a compression manager that selectively applies compression to data for one of containers 270. Memory 230 stores data for containers 270. Workload manager 250 can execute on CPU 220 or another processor or controller in the server of system 200. Workload manager 250 can manage SLAs for containers 270 and track SLI information during runtime of the containers. In one example, workload manager 250 dynamically changes a level of compression one of containers 270 based on the SLI information. System 200 can thus increase compression for one of containers 270 while maintaining performance minimums of the SLA for the container, or reduce compression to adjust performance to be within the SLA. In one example, workload manager 250 provides an indication comp 222 to adjust a level of compression in realtime for compression applied to a selected container 270.

In one example, multiple parallel compression/decompression hardware engines are available for system 200. In such a scenario, prefetch prediction 258 enables prefetches to distribute page fault handling across the parallel execution units to maximize the utilization of the hardware resources. In one example, comp 222 provides decompression hardware accelerator to enable decompressing multiple pages in parallel during a single page fault. In one example, prefetch prediction 258 includes a prefetching algorithm that identifies pages that are swapped out and will be needed in the future, which can inform the system of pages to be decompressed in parallel.

In one example, a hardware accelerator enables overlap between work on CPU 220 and work on comp 222. Prefetching, parallel decompression, and overlap of work can all contribute to reduce average page fault latency for an implementation of system 200. Prefetch prediction 258 can include a prefetching algorithm optimized for specific workloads by training a machine learning model using relevant statistics. The machine learning can learn to adapt based on relationships between the SLI and the level of compression. Trained prefetching models can be applied to the prefetching algorithm on a per container basis to containers 270. The prefetching algorithm can be tuned further using online statistics such as prefetch hit rate, memory bandwidth utilization, kernel CPU utilization, Cgroup pressure stall information, and other available statistics.

In one example, BMC 210 or fleet manager 240, or both BMC 210 and fleet manager 240, include a machine learning based workload behavioral model trained offline from platform telemetry and SLI stats. With such models, memory saving status can provide optional guidance to feedback agent 256 to enable faster convergence while tracking workload behavior to decide the best memory limit. In one example, compression agent 212 captures data samples for such models to be used to train an offline workload behavioral model.

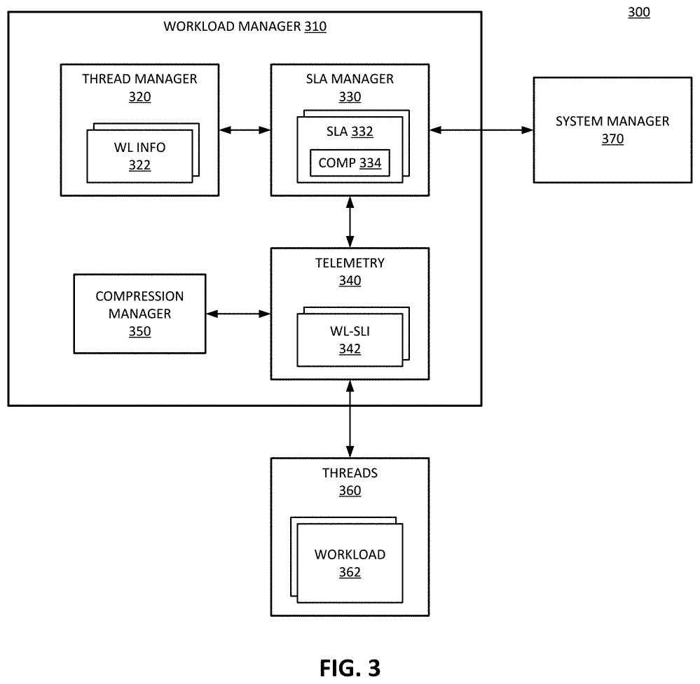

FIG. 3 is a block diagram of an example of a workload manager that tracks runtime indicators to manage memory compression for workloads. System 300 represents a system in accordance with an example of system 200 or an example of system 100. System 300 includes workload manager 310 coupled to system manager 370. Threads 360 execute on system hardware and are managed by workload manager 310.

Workload manager 310 represents a control layer to share hardware resources among multiple workloads 362 of threads 360. In one example, workload manager 310 is implemented as a virtual machine manager (VMM). In one example, workload manager 310 is implemented as a hardware controller or firmware controller in system 300. Threads 360 can include one or more workloads 362 in each thread, which represent the execution environments or execution thread for the workloads. In one example, workloads 362 are implemented as or as part of virtual machines (VMs) or as containers. Threads 360 can share hardware resources while having separate execution environments for their respective workloads 362.

Workload manager 310 can manage compression of data for memory storage for different workloads 362. In one example, workload manager 310 includes thread manager 320 to manage threads 360. Thread manager 320 can include WL (workload) info 322, which provides information about the different workloads. WL info 322 can include identifying information as well as runtime information for the threads and their workloads. In one example, SLA manager 330 is part of thread manager 320. SLA manager 330 can track SLAs for the different workloads 362.

SLA manager 330 illustrates SLAs 332, which represents SLAs for workloads 362. In one example, SLA manager 330 includes an SLA for each workload 362. SLAs 332 indicate service level agreements for workloads 362. In one example, SLAs 332 indicate a level of compression for data to be stored in memory for the workload. Comp 334 represents an indicator to indicate a level of compression for the workload to which the SLA applies.

Telemetry 340 represents gathering of runtime performance parameters for system 300. Telemetry 340 can include platform telemetry indicating operation generally of the hardware elements of system 300, as well as runtime parameters for specific workloads 362. WL-SLI (workload-service level indicator) 342 represents specific service level indicators for specific workloads 362. Thus, telemetry 340 can gather telemetry specific to workloads 362. In one example, system 300 updates comp 334 based on telemetry 340 gathered for a workload.

In one example, workload manager 310 includes compression manager 350 to manage compression for workloads 362 based on telemetry 340. SLAs 332 can indicate a compression level with comp 334, and compression manager 350 executes the compression for workloads 362 based on the indication in SLAs 332 and based on WL-SLI 342. When WL-SLI 342 indicates that more compression or less compression is tolerated by the workload to be within performance parameters of an associated SLA 332, compression manager 350 can adjust the compression level accordingly. SLA manager 330 can update the compression level indicated by comp 334 as appropriate for the workload.

System manager 370 represents a manager of workload manager 310 and other workload managers that are not depicted. workload manager 310 can be part of a system that has multiple workload managers, each managing multiple workloads 362. System manager 370 can configure system information for workload manager 310. In one example, SLA manager 330 indicates to system manager 370 changes to SLAs 332 based on WL-SLI 342. In one example, system manager 370 is a fleet manager. In one example, system manager 370 is a server manager that manages different workload managers for different processors in the server.

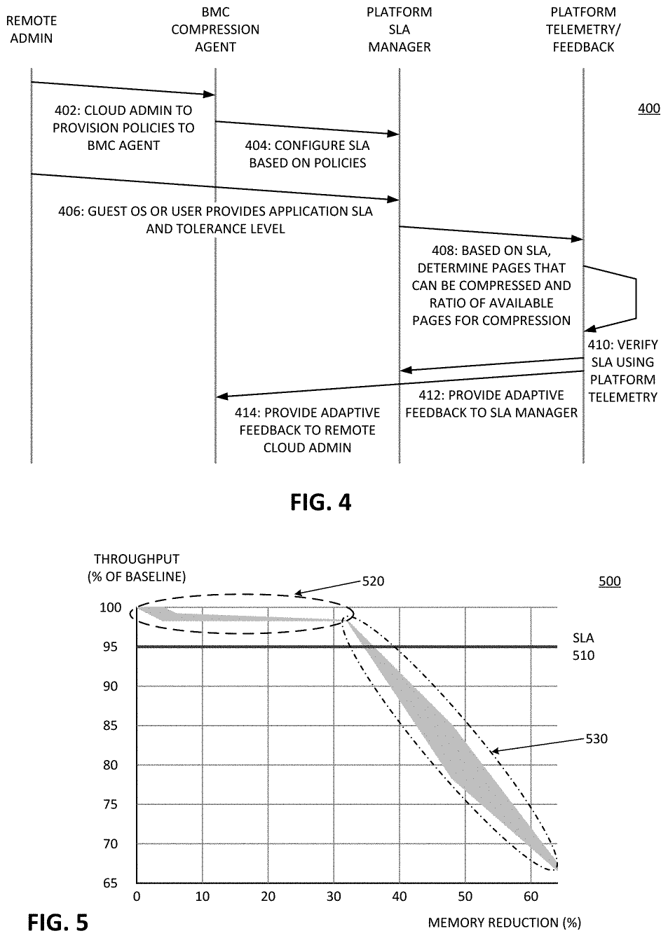

FIG. 4 is a flow diagram of an example of a process for monitoring runtime performance indicators. Flow 400 represents a swimlane diagram to indicate operations for monitoring runtime performance indicators. Flow 400 represents a process that can be executed by a system in accordance with an example of system 200.

Flow 400 illustrates interaction of a remote administrator (admin), a BMC compression agent or other compression agent that can pass SLA information, a platform SLA manager that manages SLAs for VMs in a system, and platform telemetry/feedback components that gather and send parameters related to the runtime operation of VM workloads. In one example, the remote administrator (e.g., a cloud admin or cloud fleet management agent) or a guest OS user provisions policies to the compression agent, at 402. The provisioning information allows application specific provisioning.

The BMC compression agent receives the provisioning information from the remote admin and sets the policies and configures SLAs based on the policies, at 404. The guest OS or guest OS user provides an application SLA and tolerance level for an application to be executed on the system, at 406. The platform SLA manager can receive and manage the SLA information for the application.

The platform telemetry and feedback agent(s) monitor the platform telemetry and workload SLIs to ensure that platform parameters and memory compression parameters are dynamically adjusted to meet the SLA requirements. At the same time, the agents can increase memory savings through memory page compression. Thus, the platform telemetry/feedback can determine pages that can be compressed and a ratio of available pages for compression based on the SLA information for the specific applications being executed, at 408.

The platform telemetry/feedback can reduce the impact on the workload SLIs as much as possible or bound the workload SLIs to a specific range specified by the Guest OS/Container/User. Some workloads, which are not latency-sensitive, can afford a slight degradation in performance to reduce memory footprint. In one example, a closely coupled hardware accelerator can achieve high throughput, low latency compression/decompression to lower page fault latency and limit tail latency within a specific range, which further improves the memory savings potential.

The feedback agent can estimate the amount of memory that can be squeezed and limit the allocated memory to the guest OS/container. The platform telemetry/feedback can monitor platform telemetry (e.g., memory access rates, memory pressure statistics, page-fault rates) and workload SLIs (e.g., throughput, latency). The feedback agent can then make a decision about the memory limits taking into consideration the SLI threshold set by the user or derived from the SLA provisioned for the application. Thus, the platform telemetry/feedback can gather performance parameters for the platform and the application, and verify the SLA for the application based on the telemetry gathered, at 410.

In one example, the platform telemetry/feedback can provide adaptive feedback to the SLA manager based on the telemetry gathered, at 412. In one example, the platform telemetry/feedback can provide adaptive feedback to the remote cloud administrator based on the telemetry gathered, at 414. It will be observed that the platform telemetry/feedback is shown providing feedback to the remote admin to the BMC compression agent, and the agent will then provide the feedback to the remote administrator.

Thus, the remote administrator can generate a request for execution of an application with a specific SLA. The platform can determine what policies or configuration should be updated based on runtime parameters for the application on the specific hardware platform that executes it. Communication can flow from the fleet level to the board level to the SLA manager, and then back up when adjustments should be made. Such a system can ensure a workload SLI is within the bounds of the SLA for the application workload.

FIG. 5 is a diagrammatic representation of an example of a plot of SLI response to memory reduction to trigger memory compression. Diagram 500 represents performance indicators for a workload in a system. The results represented in diagram 500 were generated for a server system having a compression engine that accelerates memory compression.

Diagram 500 provides an example of workload profiling to compare the memory saving potential from a platform telemetry (e.g., page fault rate) plus workload SLI (throughput in diagram 500) based approach. The measurement of SLI (y-axis) in response to memory reduction (x-axis) can inform the system in making decisions about how much compression to apply. Depending on the page fault threshold used in a traditional approach that uses only platform telemetry, the cold memory estimate can be different, and a different memory saving potential data point may be collected. As seen in diagram 500, tracking workload SLI leads to a more accurate memory savings estimate. Tracking workload SLI is a direct measurement as compared to simply tracking platform telemetry, which is an indirect approach.

Diagram 500 specific illustrates SLI sensitivity compared to memory page compression. The throughput (variation in the SLI, measured as percentage of baseline) is plotted against the memory reduction (measured in percentage of reduction) applied to a workload running under a Cgroup container.

Diagram 500 indicates a dark line at 95% throughput, which represents SLA 510, or the throughput acceptable under the SLA for the workload. It will be observed that portion 520 (surrounded by the dashed line) has a throughput that exceeds the SLA requirement, and thus is within the SLA. At approximately 32% memory reduction, the throughput degrades considerably. Portion 530 (surrounded by the dashed-dotted line) shows the throughput falling off sharply to below SLA 510.

It will be understood that in addition to indicating a specific throughput, the application can specify (or a manager or OS can specify) how much compression it can tolerate. The system can then watch its performance at runtime to adjust for changes. Based on diagram 500, it will be observed that the system can apply anywhere from no compression to 32% compression on data for the workload (portion 520). The system can determine how aggressive to be on the application of compression. In theory, the system can determine to apply compression up to approximately 35%, or can remain at a lower compression level to more clearly stay within the SLA.

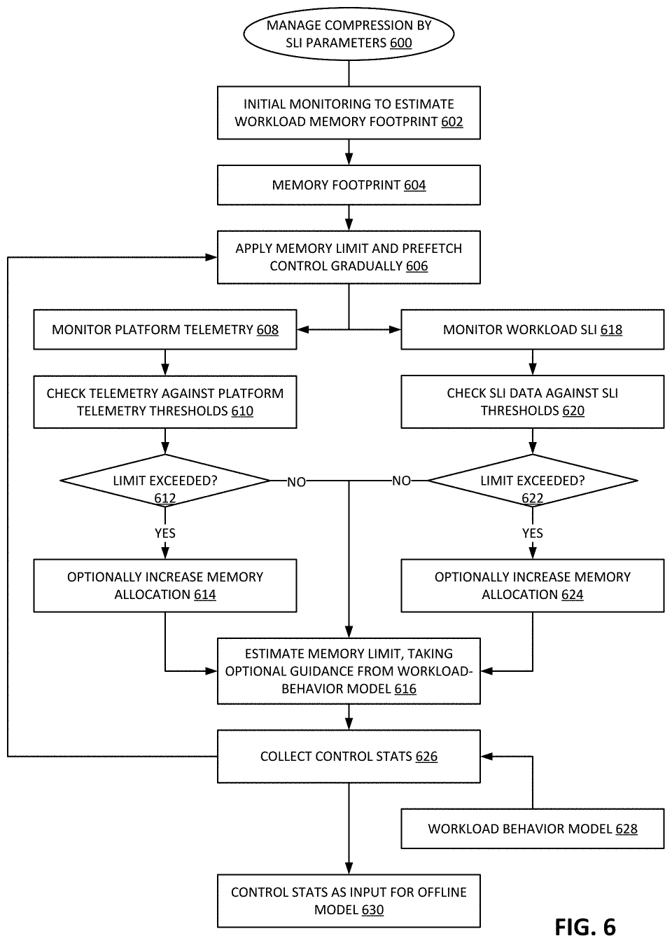

FIG. 6 is a flow diagram of an example of a process for managing compression by SLI parameters. Process 600 represents a process for managing compression by use of SLI parameters for a system in accordance with an example of system 100, 200, or 300. Process 600 can enable a multidimensional approach to allow more accurate tracking of workload behavior and finer memory limit prediction. With process 600, a system can have a faster response time to adapt to changes in the workload behavior.

The VMM can perform initial monitoring with one or more agents to estimate the workload memory footprint for a workload, at 602. The VMM agent can identify a memory footprint for the workload, at 604. The VMM can apply the memory limit and apply prefetch control gradually based on the initial footprint, at 606.

In one example, the VMM includes a telemetry agent to monitor platform telemetry, at 608. In one example, the VMM includes an SLI agent to monitor workload SLI information, at 618. For monitoring of platform telemetry, the telemetry agent can check the runtime telemetry against platform telemetry thresholds, at 610. If the threshold limit is exceeded, at 612 YES branch, in one example, the VMM optionally increases the memory allocation as the system will apply less compression, at 614. For monitoring of workload SLI, the SLI agent can check SLI data against SLI thresholds, at 620. If an SLI threshold limit is exceeded, at 622 YES branch, in one example, the VMM optionally increases memory allocation as the system will apply less compression, at 624.

If the telemetry threshold limit is not exceeded, at 612 NO branch, or the SLI threshold limit is not exceeded, at 622 NO branch, the VMM agents can estimate the memory limit, taking optional guidance from a workload behavior model, at 616. The estimate at 616 can also be performed after optionally increasing memory allocation in response to the telemetry threshold being exceeded (from 614) or after optionally increasing memory allocation in response to the SLI threshold being exceeded (from 624).

The VMM agents collect control statistics, at 626. In one example, the VMM agents receive workload behavior model information, at 628, to determine control information. The VMM agents can return to applying new memory limits and prefetch control, at 606, after collection of control statistics. Additionally, the VMM agents can control the statistics as input for an offline workload behavior model, at 630. The system can then use the workload model information as input for further computations of control parameter levels.

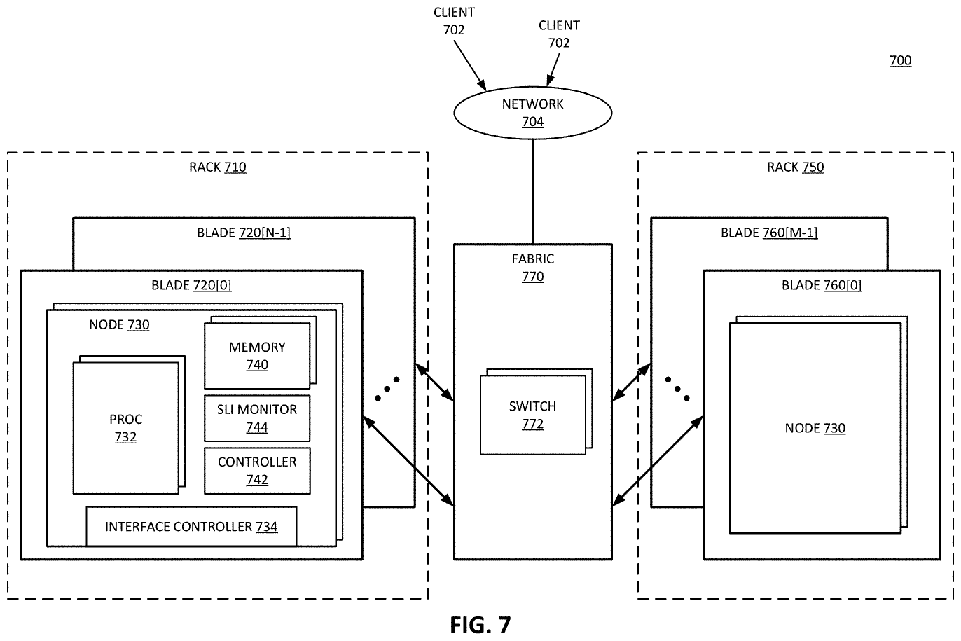

FIG. 7 is a block diagram of an example of a multi-node network in which management of compression based on SLI parameters can be implemented. System 700 represents a network of nodes that can apply SLI monitoring to apply different levels of compression for workloads. In one example, system 700 represents a data center. In one example, system 700 represents a server farm. In one example, system 700 represents a data cloud or a processing cloud.

Node 730 represents a system in accordance with an example of system 100, system 200, or system 300. In one example, node 730 includes memory 740, which can store data on which compression can be selectively applied. In one example, node 730 includes SLI monitor 744, which can monitor SLI information to change how compression is applied for one or more workloads executed on node 730. SLI monitor 744 can change SLA parameters for a workload, and can pass information to a system manager. Node 730 can apply SLI monitoring to change compression level for a workload in accordance with any example herein.

One or more clients 702 make requests over network 704 to system 700. Network 704 represents one or more local networks, or wide area networks, or a combination. Clients 702 can be human or machine clients, which generate requests for the execution of operations by system 700. System 700 executes applications or data computation tasks requested by clients 702.

In one example, system 700 includes one or more racks, which represent structural and interconnect resources to house and interconnect multiple computation nodes. In one example, rack 710 includes multiple nodes 730. In one example, rack 710 hosts multiple blade components 720. Hosting refers to providing power, structural or mechanical support, and interconnection. Blades 720 can refer to computing resources on printed circuit boards (PCBs), where a PCB houses the hardware components for one or more nodes 730. In one example, blades 720 do not include a chassis or housing or other “box” other than that provided by rack 710. In one example, blades 720 include housing with exposed connector to connect into rack 710. In one example, system 700 does not include rack 710, and each blade 720 includes a chassis or housing that can stack or otherwise reside in close proximity to other blades and allow interconnection of nodes 730.

System 700 includes fabric 770, which represents one or more interconnectors for nodes 730. In one example, fabric 770 includes multiple switches 772 or routers or other hardware to route signals among nodes 730. Additionally, fabric 770 can couple system 700 to network 704 for access by clients 702. In addition to routing equipment, fabric 770 can be considered to include the cables or ports or other hardware equipment to couple nodes 730 together. In one example, fabric 770 has one or more associated protocols to manage the routing of signals through system 700. In one example, the protocol or protocols is at least partly dependent on the hardware equipment used in system 700.

As illustrated, rack 710 includes N blades 720. In one example, in addition to rack 710, system 700 includes rack 750. As illustrated, rack 750 includes M blades 760. M is not necessarily the same as N; thus, it will be understood that various different hardware equipment components could be used, and coupled together into system 700 over fabric 770. Blades 760 can be the same or similar to blades 720. Nodes 730 can be any type of node and are not necessarily all the same type of node. System 700 is not limited to being homogenous, nor is it limited to not being homogenous.

For simplicity, only the node in blade 720[0] is illustrated in detail. However, other nodes in system 700 can be the same or similar. At least some nodes 730 are computation nodes, with processor (proc) 732 and memory 740. A computation node refers to a node with processing resources (e.g., one or more processors) that executes an operating system and can receive and process one or more tasks. In one example, at least some nodes 730 are server nodes with a server as processing resources represented by processor 732 and memory 740. A storage server refers to a node with more storage resources than a computation node, and rather than having processors for the execution of tasks, a storage server includes processing resources to manage access to the storage nodes within the storage server.

In one example, node 730 includes interface controller 734, which represents logic to control access by node 730 to fabric 770. The logic can include hardware resources to interconnect to the physical interconnection hardware. The logic can include software or firmware logic to manage the interconnection. In one example, interface controller 734 is or includes a host fabric interface, which can be a fabric interface in accordance with any example described herein.

Processor 732 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 740 can be or include memory devices and a memory controller, represented respectively, by memory 740 and controller 742.

In general with respect to the descriptions herein, in one example a computer system includes: a processor of a server device to execute a workload of an execution thread; memory to store data for the workload; a compression manager to selectively apply compression to data for the workload to store in the memory; and a workload manager to manage a service level agreement (SLA) for the workload, the SLA to indicate a performance minimum for the workload, the workload manager to track a service level indicator (SLI) during runtime of the workload, and dynamically change a level of compression for the workload based on the SLI, to increase compression while maintaining the performance minimum of the SLA.

In one example of the computer system, the workload manager is to provide an indication to the compression manager to adjust in realtime a level of compression applied by the compression manager to the workload. In accordance with any preceding example of the computer system, in one example, the workload manager comprises a workload manager implemented in software executed by the processor, or wherein the workload manager comprises a hardware controller. In accordance with any preceding example of the computer system, in one example, the compression manager comprises a compression manager implemented in software executed by the processor, or wherein the compression manager comprises a hardware circuit. In accordance with any preceding example of the computer system, in one example, the server device comprises a first server device and the computer system further comprising a second server device; and wherein the SLA includes a compression indicator to indicate a level of compression for the workload, wherein the compression indicator is specific to a server device. In accordance with any preceding example of the computer system, in one example, the workload manager comprises a first workload manager for the first server device, and wherein the second server device is to execute a second workload manager for the second server device, wherein in response to a transition of the workload from the first server device to the second server device, the first workload manager is to send telemetry for the SLI with the workload to the second workload manager. In accordance with any preceding example of the computer system, in one example, the computer system further includes: a fleet manager to manage configuration for the first server device and the second server device. In accordance with any preceding example of the computer system, in one example, the workload manager is to send telemetry for the SLI to the fleet manager, wherein the fleet manager is to update the SLA in response to the telemetry for the SLI. In accordance with any preceding example of the computer system, in one example, the computer system further includes: a baseboard management controller to transfer SLA information between the fleet manager and the workload manager. In accordance with any preceding example of the computer system, in one example, the execution thread comprises a virtual machine (VM) and the workload manager comprises a virtual machine manager (VMM). In accordance with any preceding example of the computer system, in one example, the workload manager is to update a prefetch configuration for prefetch of data from the memory based on the SLI. In accordance with any preceding example of the computer system, in one example, the workload manager is to update prefetch prediction for prefetch of data from the memory based on the SLI. In accordance with any preceding example of the computer system, in one example, to track the SLI during runtime of the workload comprises to dynamically adapt based on machine learning of a relationship between the SLI and the level of compression.

In general with respect to the descriptions herein, in one example a server system includes: a processor device to execute multiple virtual machines (VMs) and a virtual machine manager (VMM) to manage the VMs; a memory device to store data for the processor device; and a compression manager to selectively apply compression to data for one VM of the multiple VMs to store in the memory device; wherein the VMM is to manage a service level agreement (SLA) for the one VM, the SLA to indicate a performance minimum for the one VM, track a service level indicator (SLI) during runtime of the one VM, and dynamically change a level of compression for the one VM based on the SLI, to increase compression while maintaining the performance minimum of the SLA.

In one example of the server system, the VMM is to provide an indication to the compression manager to adjust in realtime a level of compression applied by the compression manager to the one VM. In accordance with any preceding example of the server system, in one example, the processor device comprises a first processor device and the server system further comprising a second processor device; and wherein the SLA includes a compression indicator to indicate a level of compression for the one VM. In accordance with any preceding example of the server system, in one example, the compression indicator is specific to a processor device. In accordance with any preceding example of the server system, in one example, the VMM comprises a VMM for the first processor device, and wherein the second processor device is to execute a second VMM for the second processor device, wherein in response to a transition of the one VM from the first processor device to the second processor device, the VMM is to send telemetry for the SLI with the one VM to the second VMM. In accordance with any preceding example of the server system, in one example, the server system includes: a fleet manager to manage configuration for the first processor device and the second processor device. In accordance with any preceding example of the server system, in one example, the VMM is to send telemetry for the SLI to the fleet manager, wherein the fleet manager is to update the SLA in response to the telemetry for the SLI. In accordance with any preceding example of the server system, in one example, the server system includes: a baseboard management controller to transfer SLA information between the fleet manager and the VMM.

In general with respect to the descriptions herein, in one example a method including: monitoring a service level indicator (SLI) during runtime of one virtual machine (VM) of multiple VMs; determining based on the SLI whether performance of the one VM is within a service level agreement (SLA) for the one VM, the SLA to indicate a performance minimum for the one VM; and dynamically changing a level of compression for the one VM based on the determination, to increase compression while maintaining the performance minimum of the SLA.

In one example of the method, the method includes: updating a compression indicator in the SLA to indicate a level of compression for the one VM. In accordance with any preceding example of the method, in one example, in response to a transition of the one VM from a first server device to a second server device, sending telemetry for the SLI with the one VM from a first virtual machine manager (VMM) of the first server device to a second VMM of the second server device. In accordance with any preceding example of the method, in one example, the method includes: sending telemetry for the SLI to a fleet manager, wherein the fleet manager is to update the SLA in response to the telemetry for the SLI.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A computer system, comprising:
a processor of a server device to execute a workload of an execution thread;
memory to store data for the workload;
a compression manager to selectively apply compression to data for the workload to store in the memory; and
a workload manager to manage a service level agreement (SLA) for the workload, the SLA to indicate a performance minimum for the workload, the workload manager to track a service level indicator (SLI) during runtime of the workload, and dynamically change a level of compression for the workload based on the SLI, to increase compression while maintaining the performance minimum of the SLA.

2. The computer system of claim 1, wherein the workload manager is to provide an indication to the compression manager to adjust in realtime a level of compression applied by the compression manager to the workload.

3. The computer system of claim 1, wherein the workload manager comprises a workload manager implemented in software executed by the processor, or wherein the workload manager comprises a hardware controller.

4. The computer system of claim 1, wherein the compression manager comprises a compression manager implemented in software executed by the processor, or wherein the compression manager comprises a hardware circuit.

5. The computer system of claim 1, wherein the server device comprises a first server device and the computer system further comprising a second server device; and
wherein the SLA includes a compression indicator to indicate a level of compression for the workload, wherein the compression indicator is specific to a server device.

6. The computer system of claim 5, wherein the workload manager comprises a first workload manager for the first server device, and wherein the second server device is to execute a second workload manager for the second server device, wherein in response to a transition of the workload from the first server device to the second server device, the first workload manager is to send telemetry for the SLI with the workload to the second workload manager.

7. The computer system of claim 5, further comprising:
a fleet manager to manage configuration for the first server device and the second server device.

8. The computer system of claim 7, wherein the workload manager is to send telemetry for the SLI to the fleet manager, wherein the fleet manager is to update the SLA in response to the telemetry for the SLI.

9. The computer system of claim 7, further comprising:
a baseboard management controller to transfer SLA information between the fleet manager and the workload manager.

10. The computer system of claim 1, wherein the execution thread comprises a virtual machine (VM) and the workload manager comprises a virtual machine manager (VMM).

11. The computer system of claim 1, wherein the workload manager is to update a prefetch configuration for prefetch of data from the memory based on the SLI.

12. The computer system of claim 1, wherein the workload manager is to update prefetch prediction for prefetch of data from the memory based on the SLI.

13. The computer system of claim 1, wherein to track the SLI during runtime of the workload comprises to dynamically adapt based on machine learning of a relationship between the SLI and the level of compression.

14. A server system, comprising:
a processor device to execute multiple virtual machines (VMs) and a virtual machine manager (VMM) to manage the VMs;
a memory device to store data for the processor device; and
a compression manager to selectively apply compression to data for one VM of the multiple VMs to store in the memory device;
wherein the VMM is to manage a service level agreement (SLA) for the one VM, the SLA to indicate a performance minimum for the one VM, track a service level indicator (SLI) during runtime of the one VM, and dynamically change a level of compression for the one VM based on the SLI, to increase compression while maintaining the performance minimum of the SLA.

15. The server system of claim 14, wherein the VMM is to provide an indication to the compression manager to adjust in realtime a level of compression applied by the compression manager to the one VM.

16. The server system of claim 14, wherein the processor device comprises a first processor device and the server system further comprising a second processor device; and
wherein the SLA includes a compression indicator to indicate a level of compression for the one VM.

17. The server system of claim 16, wherein the compression indicator is specific to a processor device.

18. The server system of claim 16, wherein the VMM comprises a VMM for the first processor device, and wherein the second processor device is to execute a second VMM for the second processor device, wherein in response to a transition of the one VM from the first processor device to the second processor device, the VMM is to send telemetry for the SLI with the one VM to the second VMM.

19. The server system of claim 16, further comprising:
a fleet manager to manage configuration for the first processor device and the second processor device.

20. The server system of claim 19, wherein the VMM is to send telemetry for the SLI to the fleet manager, wherein the fleet manager is to update the SLA in response to the telemetry for the SLI.

21. The server system of claim 19, further comprising:
a baseboard management controller to transfer SLA information between the fleet manager and the VMM.

22. A method comprising:
monitoring a service level indicator (SLI) during runtime of one virtual machine (VM) of multiple VMs;
determining based on the SLI whether performance of the one VM is within a service level agreement (SLA) for the one VM, the SLA to indicate a performance minimum for the one VM; and
dynamically changing a level of compression for the one VM based on the determination, to increase compression while maintaining the performance minimum of the SLA.

23. The method of claim 22, further comprising:
updating a compression indicator in the SLA to indicate a level of compression for the one VM.

24. The method of claim 22, wherein in response to a transition of the one VM from a first server device to a second server device, sending telemetry for the SLI with the one VM from a first virtual machine manager (VMM) of the first server device to a second VMM of the second server device.

25. The method of claim 22, further comprising:
sending telemetry for the SLI to a fleet manager, wherein the fleet manager is to update the SLA in response to the telemetry for the SLI.
